(19) United States
(12) Patent Application Publication
(10) Pub. No.: US 2016/0162236 A1
(43) Pub. Date: Jun. 9, 2016

(54) IMAGE FORMING APPARATUS, CONTROL METHOD, AND STORAGE MEDIUM

(71) Applicant: CANON KABUSHIKI KAISHA, Tokyo (JP)

(72) Inventor: Hiroshi Mori, Tokyo (JP)

(21) Appl. No.: 14/956,712

(22) Filed: Dec. 2, 2015

(30) Foreign Application Priority Data
Dec. 5, 2014 (JP) 2014-246659

(51) Int. Cl. G06F 3/12; H04N 1/00

(52) U.S. Cl. CPC G06F 3/1256; G06F 3/1211; G06F 3/125; G06F 3/1286; H04N 1/00408; G06F 3/1259; H04N 2201/0094

(57) ABSTRACT

An image forming apparatus includes an object processing time information acquiring unit configured to extract object processing time information of an object for every page, a layout-specific object processing time information acquiring unit configured to extract layout-specific object processing time information about drawing of the object for every predetermined layout, and an image forming processing time estimating unit configured to estimate a time of an image forming process based on the object processing time information and the layout-specific object processing time information.

### BACKGROUND OF THE INVENTION

1. Field of the Invention

The present invention relates to an image forming apparatus, a control method, and a storage medium.

2. Description of the Related Art

Conventionally, a function of notifying a user who performs a printing process of a time required for the printing process is implemented. Japanese Patent Laid-Open No. 2011-239071 discloses an image forming apparatus that generates an image based on a program document in a page description language (PDL) and generates a thumbnail. In Japanese Patent Laid-Open No. 2011-239071, a processing time until the thumbnail image is estimated from the program document based on a feature quantity extracted from the program document, resolution, and a reduction scheme is calculated. Here, the feature quantity is obtained by multiplying each of a data size of a command included in the program document and the number of commands by a coefficient.

However, the time required for the image forming process may differ according to an image orientation in which an image forming process is performed even on data described in the same PDL. For example, in an image forming processing method of performing the image forming process in units of lines, the image forming process is performed after dividing one object into line-specific objects. At this time, because one object is divided according to the number of heights of the object, the number of divisions differs according to an image orientation and the time required for the image forming process also differs according to the image orientation. It is necessary to efficiently provide the notification of the accurate time required for the printing process according to a layout change such as a setting change of the image orientation from the user.

### SUMMARY OF THE INVENTION

The present invention provides an image forming apparatus capable of accurately estimating a time of an image forming process according to a layout without increasing a load required for estimation.

According to an embodiment of the present invention, an image forming apparatus includes a first extracting unit configured to extract first object-related information about drawing of an object for every page; a second extracting unit configured to extract second object-related information about drawing of the object for every predetermined layout; and an estimating unit configured to estimate a time of an image forming process based on the first object-related information and the second object-related information.

Further features of the present invention will become apparent from the following description of exemplary embodiments (with reference to the attached drawings).

### BRIEF DESCRIPTION OF THE DRAWINGS

FIGS. 1A and 1B are diagrams illustrating configurations of a system and hardware of an image forming apparatus.

FIG. 2 is a diagram illustrating a configuration of software of the image forming apparatus.

FIG. 3 is a flowchart illustrating a storing process during document submission of the image forming apparatus.

FIG. 4 is a flowchart illustrating an acquiring process of object processing time information.

FIG. 5 is a conceptual diagram of a management list for managing object processing time information.

FIG. 6 is a diagram illustrating an example of page information according to an image orientation.

FIG. 7 is a diagram illustrating an acquiring process of layout-specific object processing time information.

FIG. 8 is a diagram illustrating an example of object-related information which changes according to a layout.

FIG. 9 is a diagram illustrating an example of object-related information which changes according to a layout.

FIG. 10 is a diagram illustrating an example of object-related information which changes according to a layout.

FIG. 11 is a flowchart illustrating a process of estimating and displaying a print processing time of a print setting time.

FIG. 12 is a flowchart illustrating a layout information acquiring process.

FIG. 13 is a diagram illustrating examples of an image orientation and a reduction ratio according to a print setting.

FIG. 14 is a flowchart illustrating an acquiring process of object processing time information.

FIG. 15 is a flowchart illustrating an acquiring process of layout-specific object processing time information.

FIG. 16 is a flowchart illustrating print processing time estimation according to layout information.

### DESCRIPTION OF THE EMBODIMENTS

Hereinafter, embodiments of the present invention will be described with reference to the drawings.

### First Embodiment

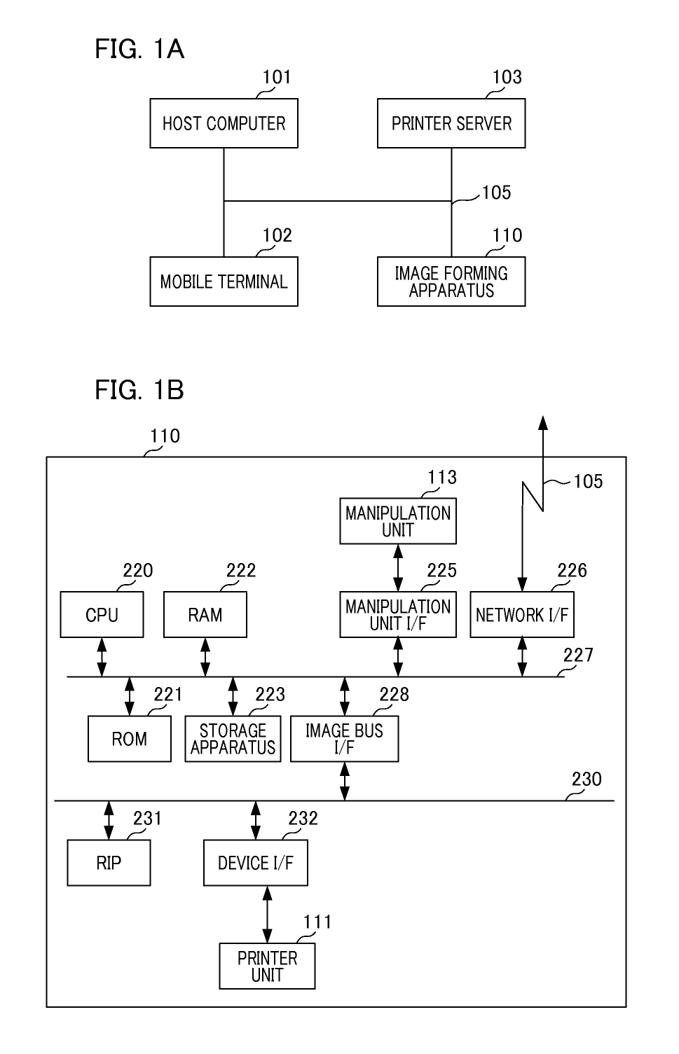

FIG. 1A is a diagram illustrating an example of a system configuration according to the present embodiment.

The system of the present embodiment includes a host computer 101, a mobile terminal 102, a printer server 103, and an image forming apparatus 110 that are connected to one another via a local area network (LAN) 105.

The user generates PDL data indicating page information to be printed from the host computer 101 or the mobile terminal 102 and transmits the generated PDL data to the printer server 103 or the image forming apparatus 110. The printer server 103 or the image forming apparatus 110 holds the transmitted PDL data (hereinafter referred to as a storing process). The user performs a print setting (layout setting) on the PDL data stored in the image forming apparatus 110 and performs a print instruction. The image forming apparatus according to the present embodiment may be either a multi-function printer (MFP) or a single function printer (SFP). In addition, the image forming apparatus may be a printer other than the MFP or SFP.

FIG. 1B is a diagram illustrating an example of a hardware configuration of the image forming apparatus according to the present embodiment.

In FIG. 1B, the image forming apparatus 110 includes a printer unit 111 which is an image output device. In addition, the image forming apparatus 110 is connected to the LAN 105 and performs control for inputting/outputting the PDL data or device information via the LAN 105. The printer unit 111 is coupled to a device interface (I/F) 232 and performs a process of outputting image data generated by the image forming apparatus 110 on paper.

A central processing unit (CPU) 220 is a central processing unit for controlling the overall image forming apparatus. A random access memory (RAM) 222 is a system work memory for enabling the CPU 220 to operate, and is an image memory for temporarily storing input image data. A read only memory (ROM) 221 is a boot ROM and stores a boot program of the system. A storage apparatus 223 is a hard disk drive, and stores system software for various types of processes and transmitted PDL data. A manipulation unit I/F 225 is an interface unit for a manipulation unit 113 having a display screen capable of displaying various types of menus, print data information, or the like, and outputs manipulation screen data to the manipulation unit 113. In addition, the manipulation unit I/F 225 plays a role in transmitting information input by a manipulator from the manipulation unit 113 to the CPU 220. The network I/F 226 is connected to the LAN 105 and inputs/outputs information with an external apparatus. The above units are disposed on a system bus 227.

An image bus I/F 228 is an interface for connecting the system bus 227 and an image bus 230 for transmitting image data at a high speed, and is a bus bridge for exchanging a data structure. On the image bus 230, a raster image processor (RIP) 231 and the device I/F 232 are connected. The RIP 231 analyzes a page description language (PDL data) code or intermediate data (display list) and expands the page description language code or intermediate data to an image. The device I/F 232 connects the printer unit 111 and the image forming apparatus 110 and performs the conversion of a synchronous system and an asynchronous system of image data.

### <Software Configuration According to Image Forming Apparatus>

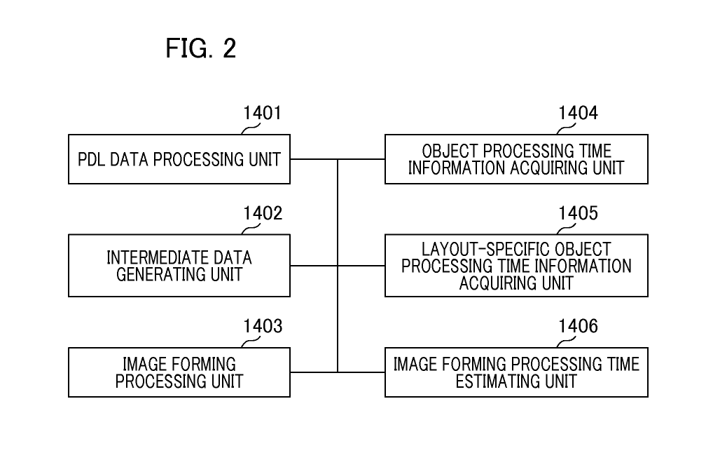

FIG. 2 is a diagram illustrating an example of a configuration of software of the image forming apparatus.

In FIG. 2, a PDL data processing unit 1401 acquires page information and an object included in the page information from PDL data received by the image forming apparatus 110, and delivers the acquired page information and object to an intermediate data generating unit 1402. The intermediate data generating unit 1402 generates intermediate data for use in an image forming process based on the page information and object information delivered from the PDL data processing unit 1401. The image forming processing unit 1403 generates a bitmap image based on the intermediate data delivered from the intermediate data generating unit 1402 (hereinafter referred to as an image forming process).

An object processing time information acquiring unit 1404 acquires information (first object-related information) necessary to estimate a time required for the image forming process to be performed by the image forming processing unit 1403 based on the intermediate data delivered from the intermediate data generating unit 1402. A layout-specific object processing time information acquiring unit 1405 performs a process of acquiring information (second object-related information) necessary to estimate a time required for the image forming process to be performed by the image forming processing unit 1403 for every predetermined layout. An image forming processing time estimating unit 1406 performs a process of estimating the time required for the image forming process based on the information delivered from the object processing time information acquiring unit 1404 and the layout-specific object processing time information acquiring unit 1405.

### <Storing Process During Document Submission According to Image Forming Apparatus>

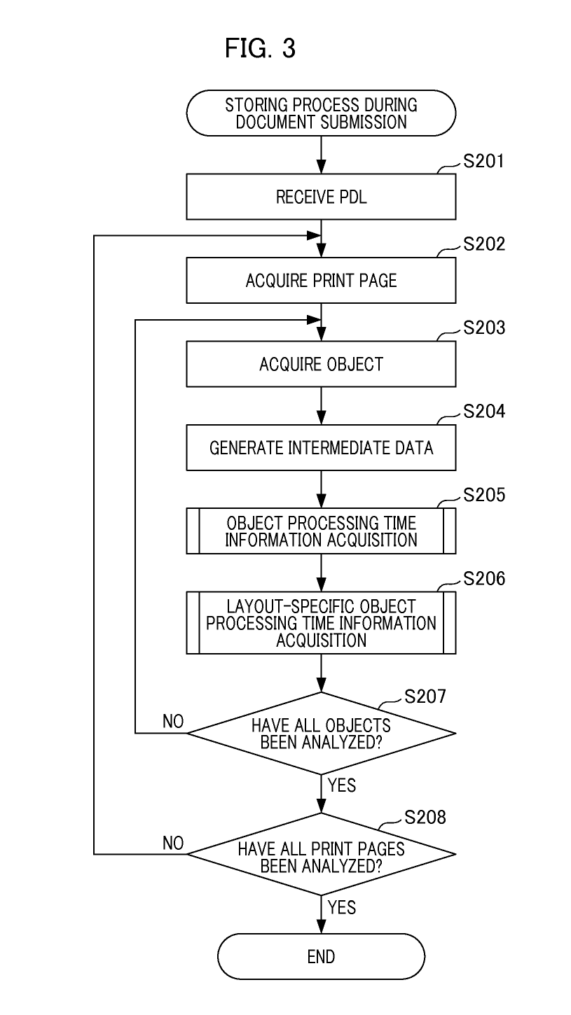

FIG. 3 is a flowchart illustrating the storing process during the document submission of the image forming apparatus according to the present embodiment.

The process illustrated in FIG. 3 is executed by the CPU 220. The CPU 220 loads a program from the ROM 221 to the RAM 222 to execute the loaded program, so that the process of FIG. 2 is implemented. Also, a configuration using the CPU 220, the ROM 221, and the RAM 222 on the image forming apparatus 110 has been described in the present embodiment, but a configuration using the CPU, the ROM, and the RAM on the printer server 103 may be used.

First, PDL data is transmitted from the host computer 101 or the mobile terminal 102 to the image forming apparatus 110.

In step S201, the CPU 220 of the image forming apparatus 110 performs a process of acquiring the received PDL data and stores the acquired PDL data in the storage apparatus 223.

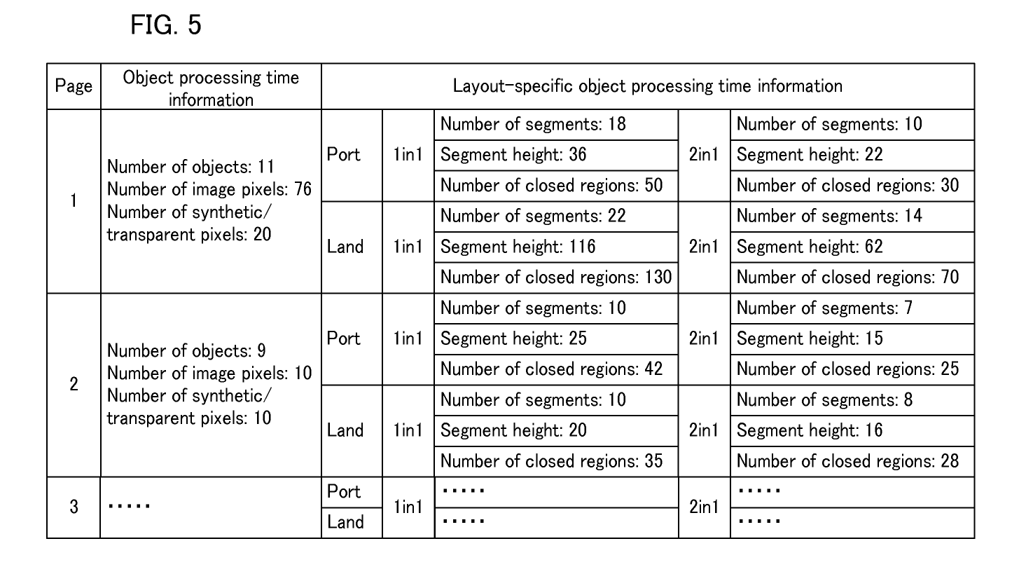

In step S202, the CPU 220 acquires page information included in the acquired PDL data. At this time, the CPU 220 performs a process of initializing a management list (print processing time calculation information list) for managing page information included in the acquired PDL data. Details of the management list and the initialization process will be described below using FIG. 5.

In step S203, the CPU 220 acquires an object included in each print page of the acquired PDL data.

In step S204, the CPU 220 generates intermediate data required for a process (hereinafter referred to as an image forming process) of generating a bitmap image from the acquired object. Also, in the present embodiment, the intermediate data is generated when an aggregate print (N-up) setting is 1 in 1 and 2 in 1.

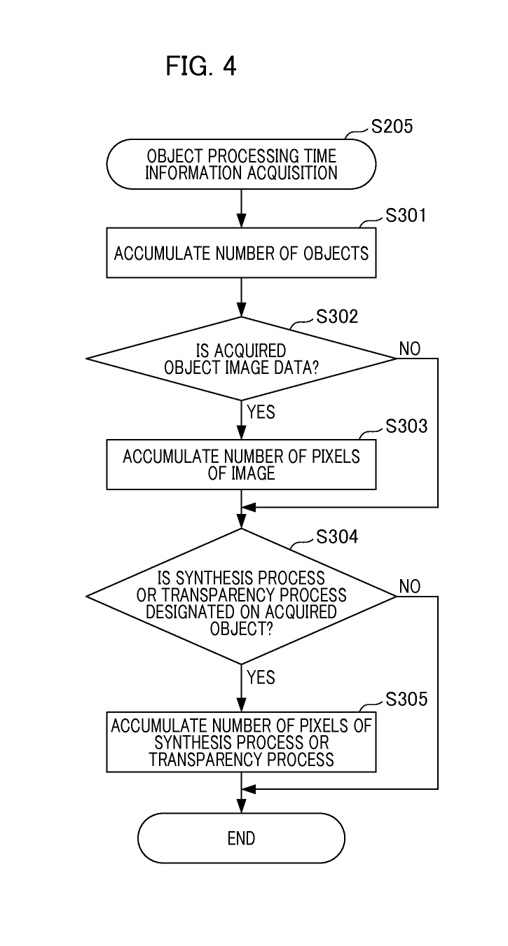

In step S205, the CPU 220 acquires object processing time information (first object-related information) necessary for estimation of the time required for the image forming process from the generated intermediate data. Also, the object processing time information to be acquired here is processing time information of an object that does not have a particularly large influence on a calculation amount during the image forming process according to a layout change or the like made by the user. Details of the information to be acquired and the process will be described below using FIGS. 4 to 6.

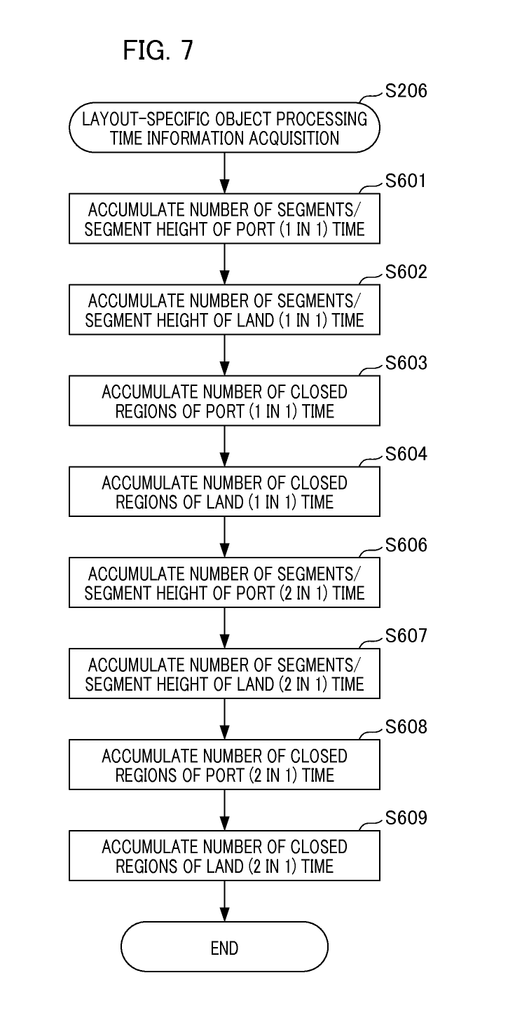

In step S206, the CPU 220 acquires layout-specific object processing time information (second object-related information) necessary for estimation of a time required for the image forming process from the generated intermediate data. Also, in particular, the layout-specific object processing time information to be acquired here is processing time information of an object for which the calculation amount during the image forming process largely changes according to a layout change or the like made by the user and this information is acquired for every layout. Details of the information to be acquired and the process will be described below using FIGS. 7 to 10.

In step S207, the CPU 220 determines whether there is an object which is not yet analyzed within the acquired print page. The process proceeds to step S203 when it is determined that there is an object which is not yet analyzed and the process proceeds to step S208 when it is determined that there is no object which is not yet analyzed.

In step S208, the CPU 220 determines whether there is a print page which is not yet analyzed within the acquired PDL data. The process proceeds to step S202 when it is determined that there is a print page which is not yet analyzed and the process ends when it is determined that there is no print page which is not yet analyzed.

### <Acquiring Process of Object Processing Time Information in Image Forming Apparatus>

Details of the acquiring process of object processing time information of step S205 in the storing process during the document submission illustrated in FIG. 3 will be described using FIGS. 4 and 5.

FIG. 4 is a flowchart illustrating the acquiring process of object processing time information of step S205 illustrated in FIG. 3. In addition, FIG. 5 is a conceptual diagram of a management list for saving and managing information acquired in the acquiring process of object processing time information (step S205) and information acquired in the layout-specific acquiring process of object processing time information (step S206) as will be described later.

The acquiring process of object processing time information acquires object information included in page information to be used in estimation of a time required for the image forming process. Also, even in the layout-specific acquiring process of object processing time information as will be described below, object information to be included in the page information is similarly acquired. However, in the layout-specific acquiring process of object processing time information, object information in which the time required for the image forming process changes according to a layout of an image orientation or the like is particularly acquired.

In step S301, the CPU 220 performs an accumulation process of accumulating the number of objects acquired in step S203. The accumulation process is a process of adding 1 to the “number of objects” in a column of “object processing time information” for every page of the management list illustrated in FIG. 5. With respect to the value of the “number of objects,” an initialization process of storing a value of 0 is first performed in the above-described step S202 and a configuration for adding a value in step S301 is adopted.

In step S302, the CPU 220 determines whether the object acquired in step S203 is data of a photo or an image (hereinafter referred to as image data). Unlike graphic data, the image data has different color information in units of pixels. It is only necessary to perform a process of coating an object region with one designated piece of color information for the graphic data. On the other hand, because color information is different in units of pixels for image data, a calculation process for selecting a color with which coating is performed according to a position within a page is necessary and a calculation amount is different from that of the graphic data. Accordingly, because a different estimating process from the graphic data is performed in the calculation of the time required for the process on the image data, a process of accumulating the number of pixels of the image data is performed in the present embodiment. The CPU 220 proceeds to step S303 when the acquired object is image data and proceeds to step S304 when there is no image data.

In step S303, the CPU 220 performs a process of accumulating the number of pixels of the image data. Because the number of pixels of the image data is configured so that the image data holds width/height information, an area of the image data is calculated based on the width/height information and area information is accumulated. In addition, a process of accumulating the number of pixels of the image data is a process of adding a value of the calculated area to the “number of image pixels” in the column of “object processing time information” for every page of the management list illustrated in FIG. 5. With respect to the value of the “number of image pixels,” an initialization process of storing a value of 0 is first performed in the above-described step S202 and a configuration for adding a value in step S303 is adopted.

In step S304, the CPU 220 determines whether the object acquired in step S203 is an object for which an instruction of a synthesis process or a transparency process is received. In the synthesis process or the transparency process, the process is performed in units of pixels and a complex calculation process is performed. Because the time required for the image forming process also changes according to the number of pixels on which the synthesis process or the transparency process is performed, a process of accumulating the number of pixels on which the synthesis process or the transparency process is performed is performed in the present embodiment. The CPU 220 proceeds to step S305 when the acquired object is the object for which the instruction of the synthesis process or the transparency process is received and ends the process when the acquired object is not the object for which the instruction of the synthesis process or the transparency process is received.

In step S305, the CPU 220 performs a process of accumulating the number of pixels for which the instruction of the synthesis process or the transparency process is received. Because the number of pixels for which the instruction of the synthesis process or the transparency process is received is configured so that the object holds width/height information indicating an outer frame, an area of a position at which the instruction of the synthesis process or the transparency process is received is calculated based on the width/height information indicating the outer frame and area information is accumulated. In addition, the accumulation process here is a process of adding the value of the calculated area to the “number of synthetic/transparent pixels” in the column of the “object processing time information” for every page of the management list illustrated in FIG. 5. With respect to the value of the “number of synthetic/transparent pixels,” an initialization process of storing a value of 0 is first performed in the above-described step S202 and a configuration for adding a value in step S305 is adopted.

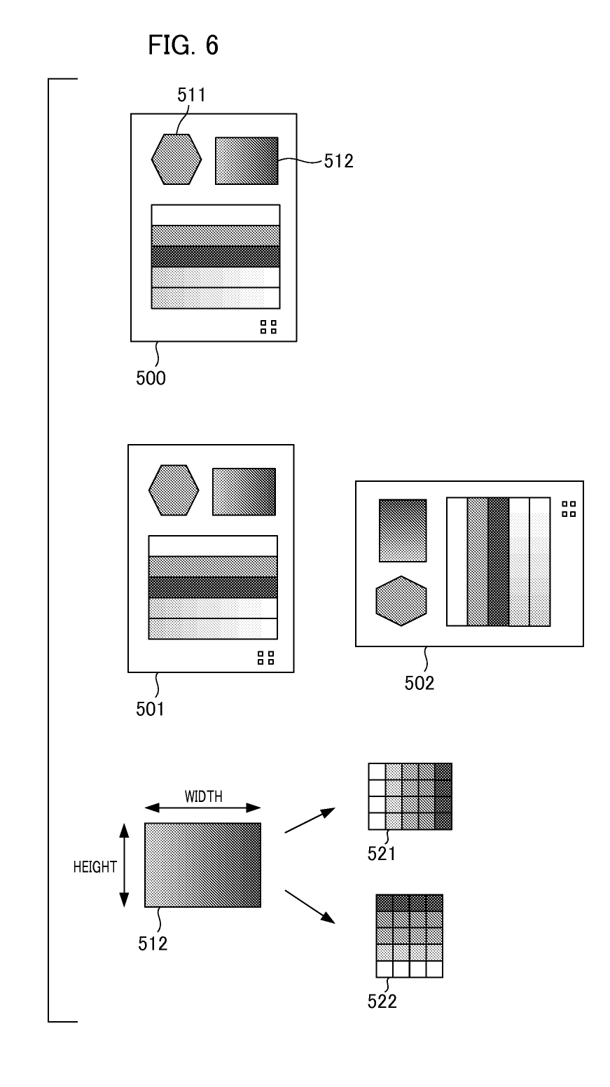

FIG. 6 is a diagram illustrating an example of page information according to an image orientation.

The case in which the information acquired through the above-described object processing time information acquisition does not depend upon a layout change will be described using FIG. 6. The layout change indicates a setting of an orientation (image orientation) of an image designated in a print setting. As a name of the orientation of a print image in the printer industry, there is “portrait” indicating the orientation of the image in which a long edge is vertical (in the vertical direction for the paper surface) and a short edge is horizontal (in the horizontal direction for the paper surface). In addition, there is “landscape” indicating the orientation of the image in which the long edge is horizontal and the short edge is vertical. Hereinafter, portrait is referred to as Port and landscape is referred to as Land. The user can set the orientation (image orientation) of the image to perform printing.

For example, when there is PDL data including page information 500 illustrated in FIG. 6, the user can set the orientation of the image to Port or Land. When the user sets Port as the orientation of the image, the image forming apparatus 110 generates an image indicated by page information (Port time) 501 of FIG. 6. In addition, when the user sets Land as the orientation of the image, the image forming apparatus 110 generates an image indicated by page information (Land time) 502 of FIG. 6. At this time, for example, in object 2 (image) 512, an area does not change according to the orientation of the image. Accordingly, the “number of image pixels” illustrated in FIG. 5 does not change according to settings of Port and Land (as 521 (Port time) and 522 (Land time) shown in FIG. 6). In addition, the same is also true for the “number of synthetic/transparent pixels.” Further, even with respect to the “number of objects,” the number of objects included within the page does not change according to the orientation of the image.

In the present embodiment, processing time information of an object for which there is no change in a calculation amount during the image forming process according to a layout change such as the orientation of the image to be performed by the user (or which does not depend upon layout information) is not held for every layout. The processing time information of the object for which there is no change in the calculation amount is configured to be managed as common processing time information for every layout. Also, from the viewpoint of data size reduction of data to be held, it is possible to further reduce a load required for estimation by adopting a configuration in which processing time information of the object for which there is no change in the calculation amount during the image forming process is not held. In addition, the object processing time information to be held may be configured to be changed according to a storage capacity or residual storage amount of the image forming apparatus. For example, when the residual storage amount of the image forming apparatus is less than a predetermined threshold value, only the object processing time information depending on a predetermined layout such as a value related to a segment or the number of closed regions may be configured to be held.

### <Layout-Specific Acquiring Process of Object Processing Time Information in Image Forming Apparatus>

Details of the layout-specific acquiring process of object processing time information of step S206 in the storing process during document submission illustrated in FIG. 3 will be described using FIGS. 7 to 10.

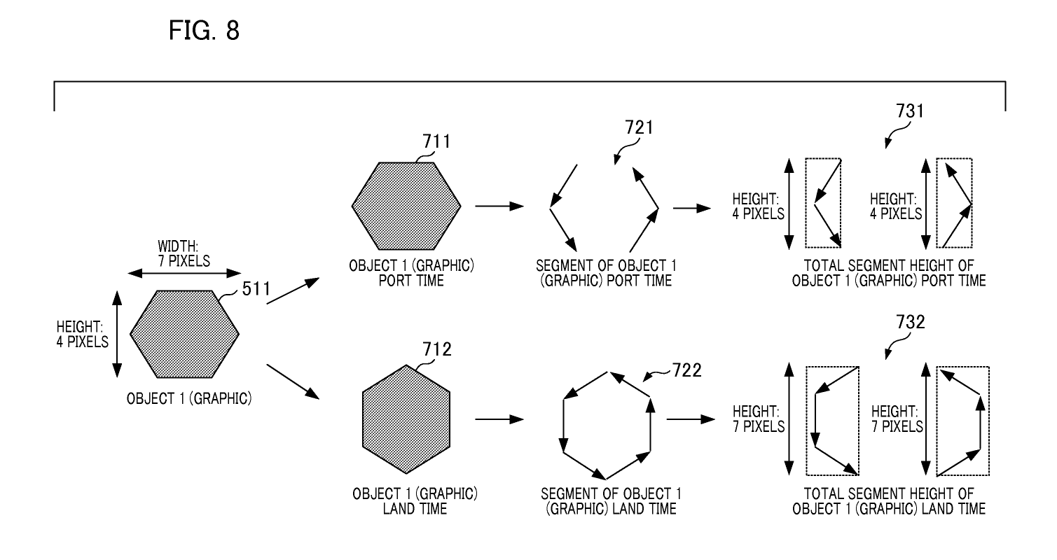

FIG. 7 is a diagram illustrating the layout-specific acquiring process of object processing time information of step S206 illustrated in FIG. 3. In addition, FIGS. 8 to 10 are conceptual diagrams of information to be acquired in the layout-specific acquiring process of object processing time information.

In steps S601 and S602, the CPU 220 performs a process of acquiring and accumulating segment information which is vector information obtained through a connection between two points of a coordinate point sequence indicating an outline of the object acquired in step S203. The segment information includes the number of segments and height information, and segment information for which the image orientation is Port and Land is acquired and accumulated.

FIG. 8 is a diagram illustrating a concept of a segment for object 1 (graphic) 511 of the page information 500 illustrated in FIG. 6.

For example, object 1 (graphic) 511 when the image orientation is Port becomes object 1 (graphic) Port time 711. At this time, the segment is constituted of four segments as in segment 721 of object 1 (graphic) Port time. In the present embodiment, the segment of the horizontal direction is unnecessary because the image forming process is performed in units of lines. Thus, the number of segments becomes a value as in segment 721. In addition, because the height of the segment becomes a sum of heights indicated by a total segment height 731 of object 1 (graphic) Port time, the segment height becomes 8 pixels.

On the other hand, object 1 (graphic) 511 when the image orientation is Land becomes object 1 (graphic) Land time 712. At this time, the segment is constituted of six segments as in segment 722 of object 1 (graphic) Land time. In addition, because the height of the segment becomes a sum of heights indicated by a total segment height 732 of object 1 (graphic) Land time, the segment height becomes 14 pixels.

As described above, because the number of segments to be processed and a segment height are different between the image orientations of Port and Land, a time required for the image forming process is also different. Accordingly, in the present embodiment, a configuration for acquiring segment information for each of the image orientations (Port and Land) is adopted.

Description will now return to the flowchart of FIG. 7. In steps S603 and S604, the CPU 220 performs a process of acquiring and accumulating the number of closed regions which are regions defined by segments on a line from the object acquired in step S203.

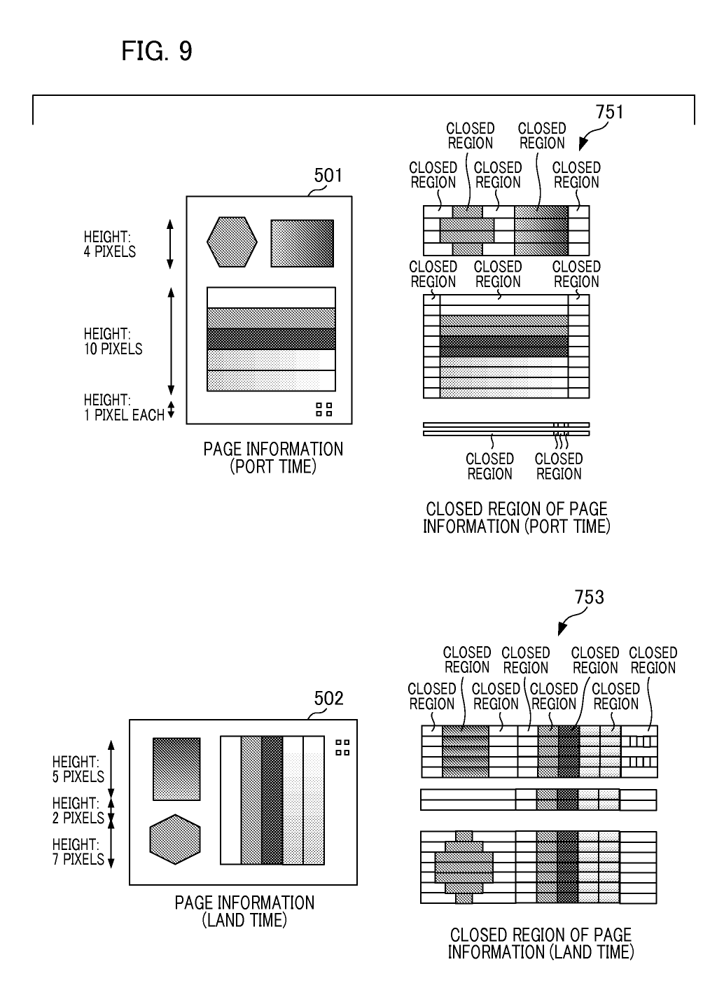

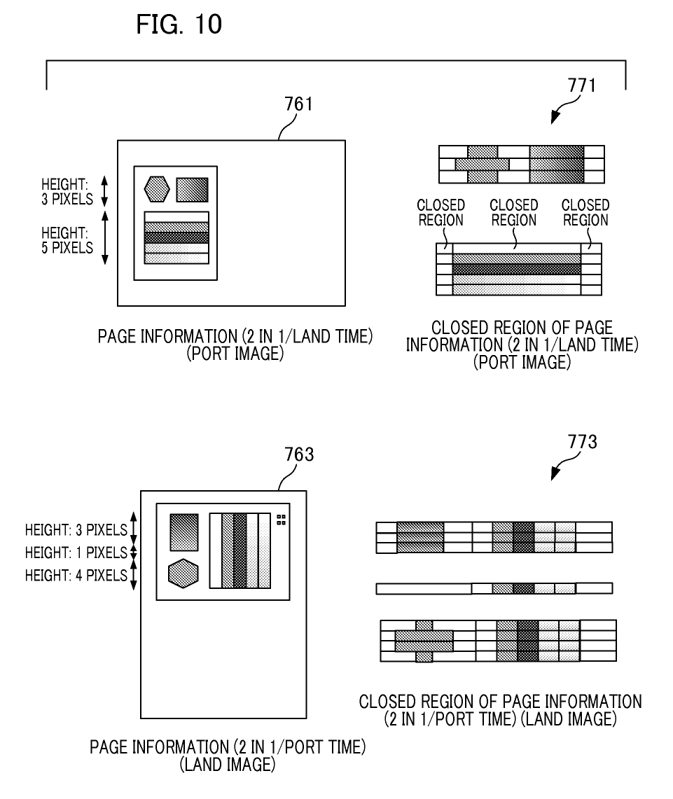

FIGS. 9 and 10 are diagrams illustrating concepts of a closed region for object 1 (graphic) 511 of the page information 500 illustrated in FIG. 6.

For example, focusing on a region in which there is an object, the closed region of page information (Port time) 501 illustrated in FIG. 9 becomes a closed region 751 of page information (Port time). At this time, the number of closed regions becomes 50 for the region including the object.

On the other hand, focusing on a region in which there is an object, the closed region of page information (Land time) 502 illustrated in FIG. 9 becomes a closed region 753 of page information (Land time). At this time, the number of closed regions becomes 130 for the region including the object.

As described above, because the number of closed regions to be processed is different between the image orientations of Port and Land, a time required for the image forming process is also different. In particular, while the number of closed regions to be processed during the image forming process is 50 in page information (Port time) 501, a processing time in which the number of closed regions to be processed during the image forming process is 130 in page information (Land time) 502 also becomes twice or more. Because the processing time for the closed region occupies a large portion of the time required for the image forming process, the processing time significantly affects calculation of the time required for the image forming process. Thus, a configuration for acquiring the number of closed regions for each of the image orientations (Port and Land) is adopted in the present embodiment.

Description will now return to the flowchart of FIG. 7. In steps S606 and S607, the CPU 220 performs a process of calculating the number of segments and a segment height in which an aggregate print setting is 2 in 1 for each of the image orientations of Port and Land. Because the number for each of 1 in 1 and 2 in 1 does not change as long as the number of segments is not reduced, the same value as at the time of 1 in 1 is accumulated. On the other hand, for the segment height of the time of 2 in 1, a value obtained by multiplying a reduction ratio in a height orientation by height information of the time of 1 in 1 is accumulated. For the calculation of a height based on the reduction ratio, well-known technology may be used. The value accumulated as described above is stored in each value of the time of 2 in 1 of the layout-specific object processing time information illustrated in FIG. 5.

In steps S608 and S609, the CPU 220 performs a process of acquiring and accumulating the number of closed regions of the time of 2 in 1 of the object acquired in step S203 for each of the imaging orientations of Port and Land. For example, focusing on a region in which there is an object, a closed region of page information (2 in 1/Land time) (Port image) 761 illustrated in FIG. 10 becomes a closed region 771 of page information (2 in 1/Land time) (Port image). At this time, the number of closed regions becomes 30 for the region including the object.

On the other hand, focusing on a region in which there is an object, a closed region of page information (2 in 1/Port time) (Land image) 763 illustrated in FIG. 10 becomes a closed region 773 of page information (2 in 1/Port time) (Land image). At this time, the number of closed regions becomes 70 for the region including the object.

As described above, because an aggregate setting (the number of aggregate pages) is 2 in 1 and the number of closed regions to be processed is different in each of the image orientations of Port and Land, the time required for the image forming process also significantly changes according to the image orientation. In particular, while the number of closed regions to be processed during the image forming process is 30 in page information (2 in 1/Land time) (Port image) 761, the number of closed regions to be processed during the image forming process is 70 in page information (2 in 1/Port time) (Land image) 763. The number of closed regions in which the image forming process is performed becomes twice or more, and thus the processing time is also different in proportion thereto. Because the processing time for the closed region occupies a particularly large portion of the time required for the image forming process, the processing time significantly affects calculation of the time required for the image forming process. Thus, a configuration for acquiring the number of closed regions for each image orientation (Port and Land) is adopted in the present embodiment.

Also, although a process when the aggregate setting is 1 in 1 and 2 in 1 has been described in the present embodiment, a configuration for storing values (for example, 4 in 1, 6 in 1, etc.) of other aggregate print setting times may be adopted.

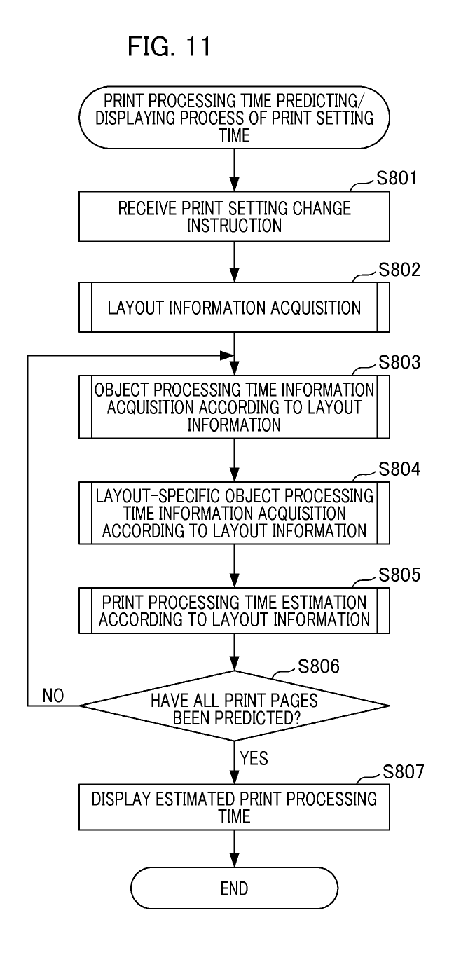

In addition, each value illustrated in FIG. 5 is stored as the object processing time information and the layout-specific object processing time information in the present embodiment, but the present invention is not limited thereto. For example, the print processing time estimation to be described below using FIG. 11 is executed in the step of a storing process and a time (estimated time information) estimated in association with each page and each layout illustrated in FIG. 5 may be stored. In this case, it may be unnecessary to store a value of each of the object processing time information and the layout-specific object processing time information. When there is a change of a print setting from the user, it is possible to estimate a processing time again according to setting content by performing conversion based on a reduction ratio (ratio) acquired in step S903 as will be described below using the stored estimated time information.

### <Process of Estimating and Displaying Print Processing Time for Print Setting Time in Image Forming Apparatus>

FIG. 11 is a flowchart illustrating the process of estimating and displaying the print processing time according to the print setting change from the user for stored print job. In the present embodiment, this process is configured to be performed for every print setting change from the user.

In step S801, the CPU 220 performs a process of receiving an instruction of a print setting change from the user.

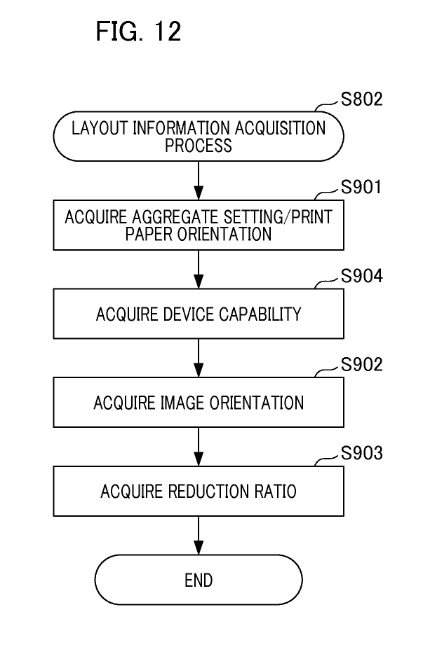

In step S802, the CPU 220 performs a process of acquiring layout information from the instruction of the print setting change acquired in step S801. Details of this process will be described below using FIG. 12.

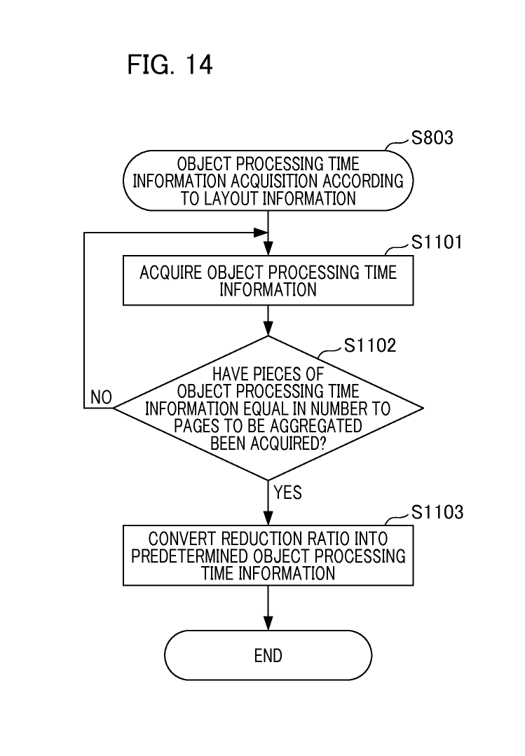

In step S803, the CPU 220 performs a process of acquiring the object processing time information according to the layout information acquired in step S802. Specifically, a process of converting the object processing time information of the management list described in FIG. 5 by a reduction ratio according to the layout information of step S802 is performed a plurality of times equal in number to pages to be aggregated within one page. Details of the process of step S803 will be described below using FIG. 14.

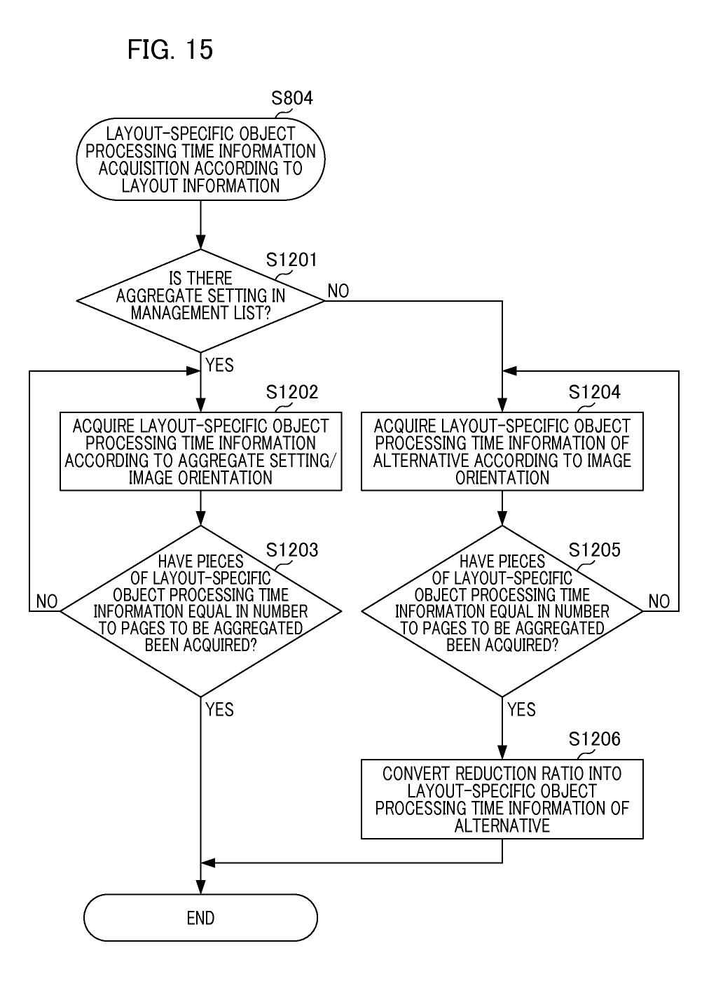

In step S804, the CPU 220 performs a process of acquiring the layout-specific object processing time information according to the layout information acquired in step S802. Specifically, a processing of converting the layout-specific object processing time information of the management list illustrated in FIG. 5 by an image orientation according to the layout information of step S802 and a reduction ratio according to the aggregate setting is performed a number of times equal in number to pages aggregated within one page. Details of the process of step S804 will be described below using FIG. 15.

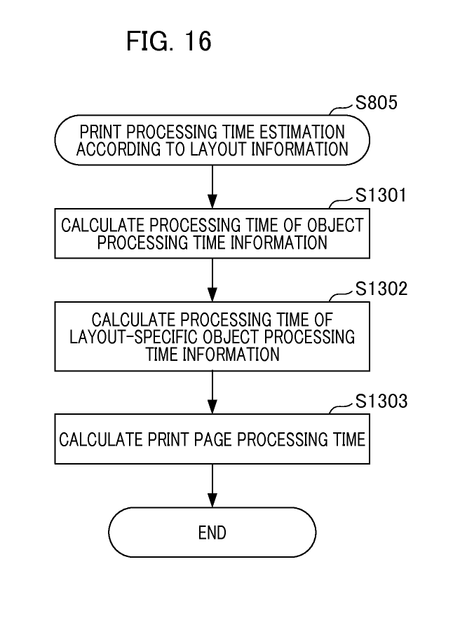

In step S805, the CPU 220 performs a process of estimating a print processing time of a print page from the object processing time information and the layout-specific object processing time information acquired in steps S803 and S804. Specifically, the print processing time is calculated by multiplying each of the object processing time information and the layout-specific object processing time information acquired in steps S803 and S804 by a predetermined coefficient. The predetermined coefficient is set as a value approximating an actual processing time per object in advance. The predetermined coefficient is configured to be held and used in advance. Also, details of the process of step S805 will be described below using FIG. 16.

In step S806, the CPU 220 determines whether all print pages included in the print job for which the print processing time is being estimated have been processed. The process proceeds to step S807 when it is determined that all the print pages have been processed and the process proceeds to step S803 when it is determined that there is a page which is not yet processed.

In step S807, the CPU 220 calculates a total value of page-specific print processing times estimated in steps S803 to S806 and displays the calculated total value as a print processing time of the print job for which the print setting change instruction is received for the user. Also, display is configured to be performed in units of print jobs, but the display of page-specific print processing times (pages) estimated in steps S803 to S806 may be configured to be performed.

Also, the process of steps S801 to S807 for every print setting change from the user is configured to be executed for a stored print job in the present embodiment, but the present invention is not limited thereto. For example, for steps S205 and S206 of the storing process during document submission illustrated in FIG. 3, steps S804 and S805 of the print processing time estimation may be executed and the estimated time may be stored to be associated as estimated time information for every predetermined layout in the management list of FIG. 5. As described above, it is only necessary to return processing time information stored in the management list in steps S803 and S804 when the print setting change is received from the user and the print processing time estimation of a print setting time of FIG. 11 is executed in the case in which the estimation time information is stored in the management list. In addition, when a print setting from the user is not included in the predetermined layout stored in the management list, it is only necessary to perform conversion based on a reduction ratio acquired in step S903 using estimation time information of any layout stored in the management list.

In addition, when the time estimated as described above is associated and stored as estimated time information for every predetermined layout in the management list, the following configuration may be adopted from the viewpoint of data size reduction of the stored information. For example, only the estimated time information may be configured to be stored without storing each value of the object processing time information or the layout-specific object processing time information such as the number of objects or the number of segments.

### <Layout Information Acquiring Process in Image Forming Apparatus>

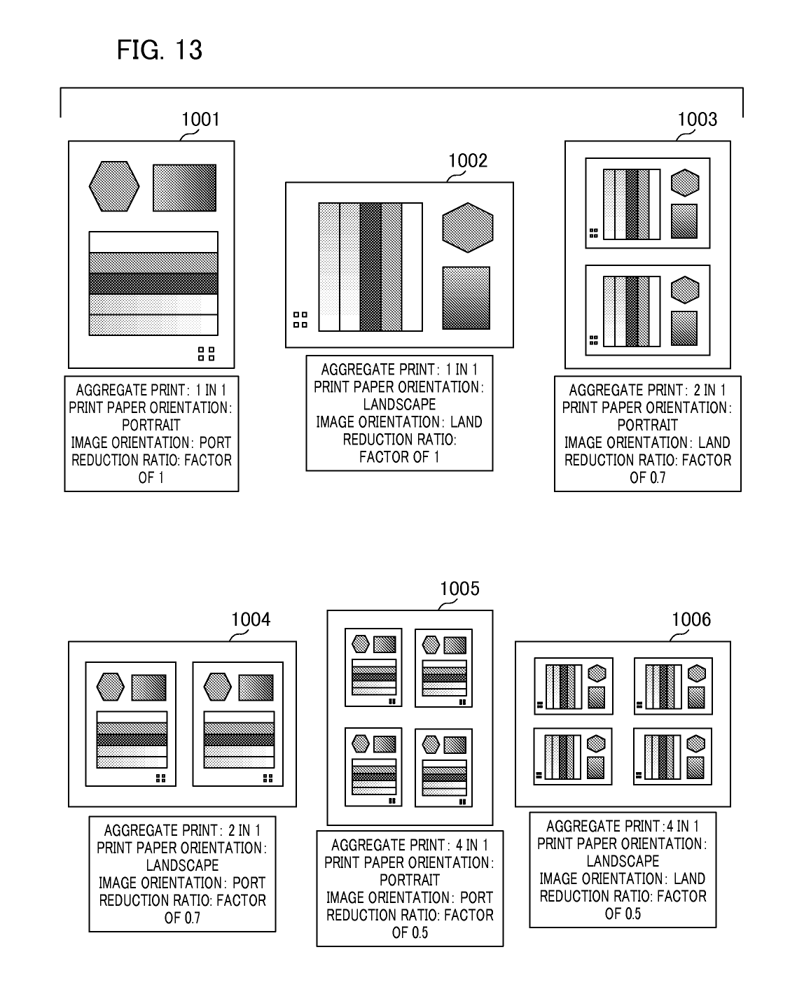

Details of the layout information acquiring process of step S802 in a print processing time estimating/displaying process of a print setting time illustrated in FIG. 11 will be described using FIGS. 12 and 13.

FIG. 12 is a flowchart illustrating the layout information acquiring process of step S802 illustrated in FIG. 11. In addition, FIG. 13 is a diagram illustrating details of information to be acquired in the layout information acquiring process.

In step S901, the CPU 220 performs a process of acquiring setting information of aggregate printing (hereinafter referred to as aggregate setting information) and orientation information of print paper (hereinafter referred to as print paper orientation information) from a print setting instruction acquired in step S801. The aggregate setting information, for example, indicates the setting of the number of pages to be printed on one piece of paper as illustrated in FIG. 13. In addition, the print paper orientation information indicates information of an orientation of paper on which printing is performed as illustrated in FIG. 13. The aggregate setting information and the print paper orientation information are configured to be acquired using well-known technology.

In step S904, the CPU 220 performs a process of acquiring device capability information of a print device for performing a print process. The device capability information, for example, is image orientation information capable of being output by the device. The image orientation in which an output is enabled by the device may be only Port or both Port and Land. Even when the user sets Land in a device in which an output is possible only in Port, a configuration in which a change to an image orientation in which an output is possible therein is adopted. Because the device capability information is also information depending upon the layout as described above, a process of acquiring the device capability information is performed in the present embodiment.

In steps S902 and S903, the CPU 220 performs a process of calculating and acquiring the image orientation and the reduction ratio per page to be aggregated from the aggregate setting information and the print paper orientation information acquired in step S901. For example, in the case of the settings of the aggregate print and the print paper orientation indicated by reference numeral 1001 of FIG. 13, the image orientation is Port and the reduction ratio is calculated as a factor of 1. A configuration in which well-known technology is used as technology of a process of calculating an image orientation and a reduction ratio according to print setting information is adopted. Even in the case of settings indicated by reference numerals 1002 to 1006, a process of calculating the image orientation and the reduction ratio illustrated in the drawing from the aggregate setting information and the print paper orientation information is similarly performed.

Also, when the device capability acquired in step S904 is an A4 device and the support of an output port is limited, the CPU 220 performs a process of acquiring the image orientation and the reduction ratio after designating the print paper orientation as Port.

### <Acquiring Process of Object Processing Time Information According to Layout Information>

FIG. 14 is a flowchart illustrating an acquiring process of object processing time information according to layout information of step S803 illustrated in FIG. 11.

In step S1101, the CPU 220 performs a process of acquiring the object processing time information of a page serving as a target of print processing time estimation. Specifically, the object processing time information of the page is acquired from the management list illustrated in FIG. 5.

In step S1102, the CPU 220 performs a process of determining whether pieces of the object processing time information equal in number to the number of pages to be aggregated indicated by the aggregate setting information acquired in step S901 have been acquired. Here, a process of acquiring object processing time information of a sum of all pages included within one page is performed by iterating the process of step S1101 a plurality of times equal in number to pages to be aggregated. The process proceeds to step S1103 when it is determined that the acquisition of the pieces of object processing time information equal in number to the pages to be aggregated has been completed and the process proceeds to step S1101 when it is determined that the acquisition is not completed.

In step S1103, the CPU 220 performs a process of acquiring (correcting) object processing time information according to a reduction process to be performed during aggregate printing by multiplying the reduction ratio acquired in step S903 by a predetermined object processing time information value. Specifically, because the “number of objects,” which is object processing time information, does not change according to an aggregate setting in the present embodiment, the correction in which the reduction ratio is multiplied by a value of the “number of objects” is not performed. On the other hand, because the “number of image pixels” and the “number of synthetic/transparent pixels” change according to the aggregate setting, the “number of image pixels” and the “number of synthetic/transparent pixels” are corrected by multiplying the reduction ratio as predetermined object processing time information. Accordingly, the object processing time information according to layout information per page to be aggregated is as follows.

Object processing time information accoording to layout information={Number of objects, Number of image pixels Reduction ratio, Number of synthetic/transparent pixels Reduction ratio}

In addition, as described above, in an acquiring process of object processing time information (step S803) according to the layout information, the object processing time information of a sum of all pages included in one page when aggregate printing is finally performed is acquired. Thus, the following calculation is performed and the object processing time information according to the layout information is output.

Object processing time information (output of step S803) according to layout information={Number of objects (for pages to be aggregated within one page), Number of image pixels (for pages to be aggregated within one page), Number of synthetic/transparent pixels (for pages to be aggregated within one page)}

### <Layout-Specific Acquiring Process of Object Processing Time Information According to Layout Information>

FIG. 15 is a flowchart illustrating the layout-specific acquiring process of object processing time information according to the layout information of step S804 illustrated in FIG. 11.

In step S1201, the CPU 220 determines whether the aggregate setting acquired in step S901 is in the layout-specific object processing time information of the management list illustrated in FIG. 5. There is information of 1 in 1 and 2 in 1 in the layout-specific object processing time information of the management list illustrated in FIG. 5. Therefore, it is only necessary to determine whether the aggregate setting acquired in step S901 is 1 in 1 or 2 in 1. The process proceeds to step S1202 when the aggregate setting is 1 in 1 or 2 in 1 (there is aggregate setting) and the process proceeds to step S1204 when the aggregate setting is not 1 in 1 or 2 in 1 (there is no aggregate setting).

In step S1202, the CPU 220 performs a process of acquiring the layout-specific object processing time information according to an image orientation of a page serving as a target of print processing time estimation. Specifically, the aggregate setting acquired in step S901 and the layout-specific object processing time information of the page according to the image orientation acquired in step S902 are acquired from the management list illustrated in FIG. 5.

In step S1203, the CPU 220 performs a process of determining whether pieces of the layout-specific object processing time information equal in number to pages to be aggregated indicated by the aggregate setting information acquired in step S901 have been acquired. Here, a process of acquiring layout-specific object processing time information of a sum of all pages included within one page is performed when aggregate printing is performed by iterating the process of step S1202 a plurality of times equal in number to pages to be aggregated. Therefore, the process proceeds to step S1202 when it is determined that the acquisition of the pieces of the information equal in number to the pages to be aggregated is not completed and the process ends when it is determined that the acquisition is completed.

In step S1204, the CPU 220 performs a process of acquiring the layout-specific object processing time information for use as an alternative. Here, a configuration for acquiring the layout-specific object processing time information in which the aggregate setting is 1 in 1 is adopted, but the layout-specific object processing time information of another aggregate setting in the management list may be acquired.

In step S1205, the CPU 220 performs a process of determining whether pieces of the layout-specific object processing time information equal in number to pages to be aggregated indicated by the aggregate setting information acquired in step S901 have been acquired. Here, a process of acquiring layout-specific object processing time information of a sum of all pages included within one page is performed when aggregate printing is performed by iterating the process of step S1204 a plurality of times equal in number to pages to be aggregated. Therefore, the process proceeds to step S1204 when it is determined that the acquisition of the pieces of the information equal in number to the pages to be aggregated is not completed and the process proceeds to S1206 when it is determined that the acquisition is completed.

In step S1206, the CPU 220 calculates reduction ratios of an aggregate setting acquired in step S901 and an aggregate setting (1 in 1 in this example) of the layout-specific object processing time information of the alternative acquired in step S1204. A process of performing conversion (correction) based on the reduction ratio for the aggregate setting acquired in step S901 and acquiring the layout-specific object processing time information during reduction is performed. For example, because the “number of segments,” which is object processing time information, does not change according to an aggregate setting in the present embodiment, the conversion (correction) based on the reduction ratio is not performed. In addition, a “segment height” and the “number of closed regions” are converted according to the calculated reduction ratio because the “segment height” and the “number of closed regions” change according to the aggregate setting. Accordingly, the layout-specific object processing time information according to the layout information per page to be aggregated is as follows.

Layout-specific object processing time information according to layout information={Number of segments, Segment height*Reduction ratio, Number of closed regions*Reduction ratio}

In addition, as described above, in the layout-specific acquiring process of object processing time information (step S804) according to the layout information, the layout-specific object processing time information of a sum of all pages included within one page when aggregate printing is finally performed is acquired. Thus, the following calculation is performed and a calculation result is output as the layout-specific object processing time information according to the layout information.

Layout-specific object processing time information (output of step S804) according to layout information={Number of segments (for pages to be aggregated within one page), Segment height (for pages to be aggegated within one page), Number of closed regions (for pages to be aggregated within one page)}

### <Print Processing Time Estimating Process According to Layout Information>

FIG. 16 is a flowchart illustrating print processing time estimation according to layout information of step S805 illustrated in FIG. 11.

In step S1301, the CPU 220 calculates a processing time of the object processing time information. Specifically, the following calculation process is performed using the object processing time information acquired in step S803.

Processing time of object processing time information=Number of objects (for pages to be aggregated within one page)*Coefficient 1+Number of image pixels (for pages to be aggregated within one page)*Coefficient 2+Number of synthetic/transparent pixels (for pages to be aggregated within one page)*Coefficient 3

In step S1302, the CPU 220 calculates a processing time of the layout-specific object processing time information. Specifically, the following calculation process is performed using the layout-specific object processing time information acquired in step S804.

Processing time of layout-specific object processing time information=Number of segments (for pages to be aggregated within one page)*Coefficient 4, +Segment height (for pages to be aggregated within one page*Coefficient 5, +Number of closed regions (for pages to be aggregated within one page)*Coefficient 6

In step S1303, the CPU 220 calculates a processing time of a print page from the processing time of the object processing time information and the processing time of the layout-specific object processing time information acquired in steps S1301 and S1302. Specifically, the following calculation process is performed.

Print processing time (page)=Processing time of object processing time information+Processing time of layout-specific object processing time information

Also, although the case in which the estimation of the print processing time is performed when there is a change of a layout setting from the user has been described in the present embodiment, the present invention is not limited thereto. For example, even when there is an instruction for coupling different types of print documents from the user, it is possible to apply the estimation of the print processing time of the present embodiment. Specifically, for example, the case in which a Power Point document is coupled to a Word document and a layout for the Word document is designated by the user is considered. At this time, it is possible to calculate a print processing time by determining a layout of an image orientation or the like of the Power Point document according to a layout of the Word document and extracting the processing time information according to the layout of each document from the management list.

As described above, according to the present embodiment, the time required for the image forming process according to the instruction or change of the layout can be estimated accurately and without increasing the load required for the estimation.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transistory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-246659, filed Dec. 5, 2014, which is hereby incorporated by reference wherein in its entirety.

What is claimed is:

1. An image forming apparatus comprising:
a first extracting unit configured to extract first object-related information about drawing of an object for every page;
a second extracting unit configured to extract second object-related information about drawing of the object for every predetermined layout; and
an estimating unit configured to estimate a time of an image forming process based on the first object-related information and the second object-related information.

2. The image forming apparatus according to claim 1, further comprising:
a storing unit configured to associate the first object-related information and the second object-related information with the time estimated by the estimating unit to save the associated information as estimated time information,
wherein, according to reception of a setting of a layout from a user, the estimating unit estimates the time of the image forming process again based on the received setting of the layout and the estimated time information.

3. The image forming apparatus according to claim 1, further comprising:
a storing unit configured to save the time estimated by the estimating unit as the estimated time information,
wherein, according to reception of a setting of a layout from a user, the estimating unit estimates the time of the image forming process again based on the received setting of the layout and the estimated time information.

4. The image forming apparatus according to claim 1, wherein the predetermined layout is an image orientation and a number of aggregated pages.

5. The image forming apparatus according to claim 1, wherein the estimating unit corrects the first object-related information and the second object-related information according to setting content of the layout and estimates the time of the image forming process by multiplying a predetermined coefficient.

6. The image forming apparatus according to claim 3, wherein the estimating unit estimates the time of the image forming process again by multiplying the estimated time information by a predetermined coefficient according to setting content of a layout.

7. The image forming apparatus according to claim 1, wherein the first object-related information includes at least any one of a number of objects included in an image, a number of image pixels, and a number of pixels for which an instruction of a synthesis process or a transparency process is received.

8. The image forming apparatus according to claim 1, wherein the second object-related information includes any one of a number of segments which is vector information representing an outline of an object of an image, a height of the segment, and a number of closed regions which are regions defined by the object and the segment.

9. The image forming apparatus according to claim 1, wherein the estimating unit estimates a time of the image forming process according to capability of a device for performing the image forming process.

10. The image forming apparatus according to claim 1, wherein the first extracting unit and the second extracting unit change the first and the second object-related information to be calculated according to a storage capacity or a residual storage amount of the image forming apparatus.

11. The image forming apparatus according to claim 1, wherein, according to reception of an instruction for coupling different types of documents from a user, the estimating unit determines an image orientation of the documents to be coupled according to a layout of the documents to be coupled and estimates the time of the image forming process according to the image orientation.

12. The image forming apparatus according to claim 1, further comprising:
a display unit configured to display the time estimated by the estimating unit.

13. A method for controlling an image forming apparatus comprising:
extracting first object-related information about drawing of an object for every page;
extracting second object-related information about drawing of the object for every predetermined layout; and
estimating a time of an image forming process based on the first object-related information and the second object-related information.

14. A non-transitory storage medium storing a computer program for making a computer function as respective units of an image forming apparatus, the image forming apparatus comprising:
a first extracting unit configured to extract first object-related information about drawing of an object for every page;
a second extracting unit configured to extract second object-related information about drawing of the object for every predetermined layout; and
an estimating unit configured to estimate a time of an image forming process based on the first object-related information and the second object-related information.
